(19) United States
(12) Patent Application Publication
(10) Pub. No.: US 2012/0237917 A1
(43) Pub. Date: Sep. 20, 2012

(54) Student Specific Information System

(76) Inventor: Ramji Venkatachari, Herndon, VA (US)

(21) Appl. No.: 13/047,785

(22) Filed: Mar. 14, 2011

(51) Int. Cl. G09B 5/00

(52) U.S. Cl. 434/350

(57) ABSTRACT

A system for sharing student-specific information comprises of a server, a client, in communication with the server, and a student-specific application. The application comprises a school portal, user portal, activity portal and a system portal for remotely sharing student-specific data with the server, to facilitate communication between a user and selected school.

### FIELD OF THE INVENTION

The invention relates to a system and/or application for facilitating remote sharing of student-related information.

### BACKGROUND

The present invention enables users to remotely access and share student-specific information. The present invention is an easy to use web and mobile application for all types of schools (i.e. colleges, high schools, etc.) and remote users, such as the parents and guardians. The application collects critical student contact and health information from a user, such as a parent and shares the information with schools and school administrators.

Schools can use the student-specific information to engage in communication with the parents. In the event of an emergency, schools and parents can utilize this information to communicate with first responders, such as paramedics, firemen, and doctors. The system enables users, such as parents or the student, to update the student's information, thereby shifting the responsibility of student record maintenance to the parents.

The system further enables users, such as students, to perform school specific functions such as registration for various school activities, or provide support to the fund raising efforts of the school. Other school related organizations such as, Parent Teachers Association (“PTA”) and other Activity Managers (authorized by the School) have the ability to setup and manage school related activities. For example, users and/or parents, can register their child for a field trip remotely, or online, and pay for the activity fees online using a computer, smart phone, or similar remote client.

The result of parent and user involvement will assist schools significantly in increasing student and parental involvement, as well as further boost their fund raising efforts. The system will keep the school involved in the information management cycle for their prompt review and approval process.

The student information system uses leading edge technologies to deliver a multitude of functions to the users. To harness the exponential growth in the use of smart phones and other similar clients

### SUMMARY OF THE INVENTION

This summary is provided to introduce concepts in a simplified form that are further described in the detailed description of the invention. This summary is not intended to identify key or essential inventive concepts of the claimed subject matter, nor is it intended for determining the scope of the claimed subject matter.

The present invention provides a system for sharing student-specific information comprising of one or more servers, a client, in communication with the server, and a student-specific application. The application comprises a school portal, user portal, activity portal and a system portal for remotely sharing student-specific data with the server, to facilitate communication between a user and selected school.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and instrumentalities disclosed herein.

FIGS. 1-3 illustrate diagrams of the system of the present invention, wherein,

FIG. 1 illustrates a schematic diagram illustrating one example of the system;

FIG. 2 illustrates a schematic of the portals the system of the present invention; and,

FIG. 3 illustrates detailed examples of the portal functions of the system.

### DETAILED DESCRIPTION OF EXEMPLARY EMBODIMENTS

Particular embodiments of the present invention will now be described in greater detail with reference to the figures.

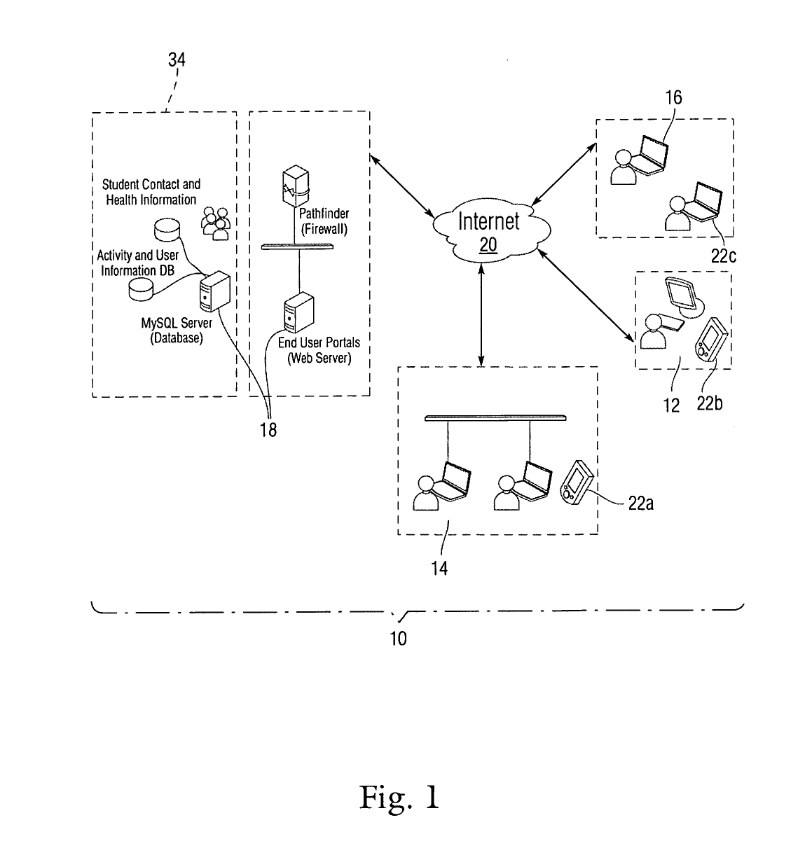

Referring now to the diagrams, FIG. 1 illustrates one example of the system 10. As shown, the system 10 comprises one or more remote users, which can be for example, parents 12, the school 14, and external service providers 16. The users are in communication with a DMZ server 18 within the system 18 via the internet 20, or telecommunication network, or other remote technology, generally known in the art. Each user has a respective client 22a, 22b, and 22c, enabling remote access to the server 18. It is contemplated that the client 22a, 22b, 22c can be a smart phone, computer, PDA, or any other type of communication device providing remote access, generally known in the art. The client 22 accesses a student-specific information application 24 or program. The application 24 is used in conjunction with the client 22 to communicate with a server 18 and system 10. As further shown, the server 18 is in communication with a Local Area Network Server (“LAN”) 34, which stores and controls student-specific information. As illustrated, examples of student-specific information are activity, user, and student contact and health information. Notably, other types of student-specific information are contemplated, without departing from the scope of the present invention.

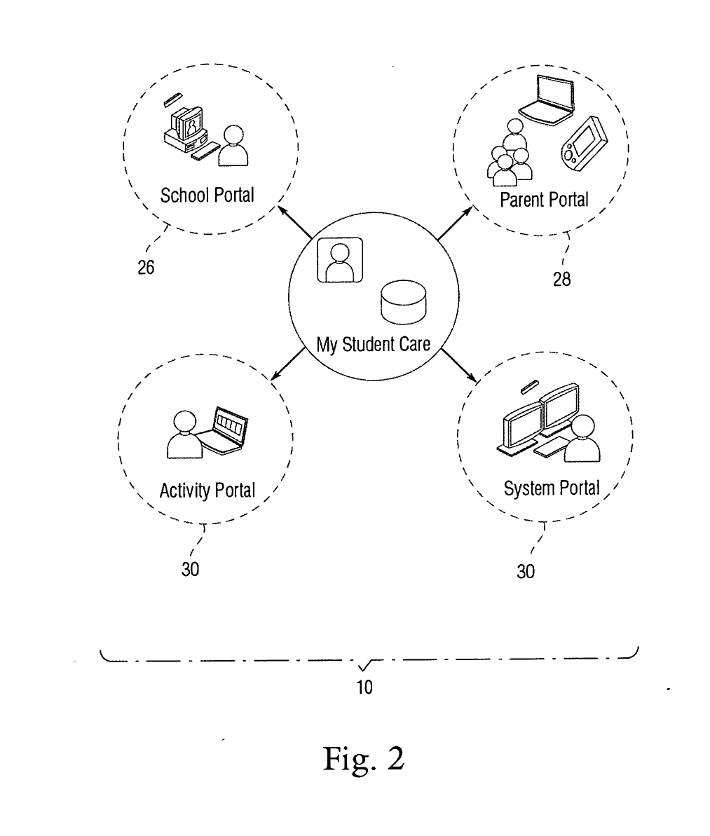

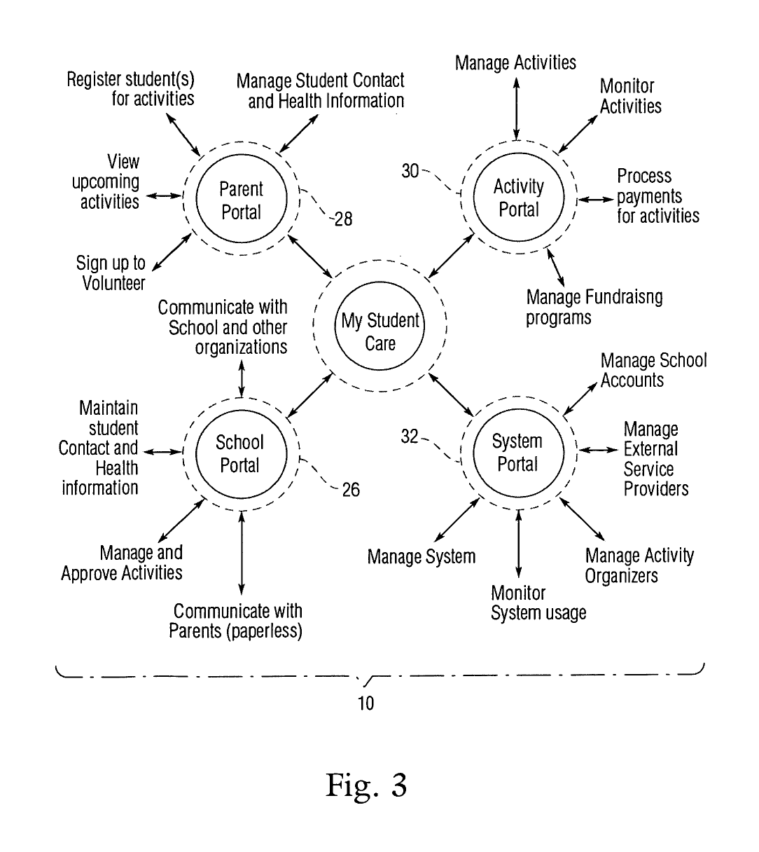

The application 24 can be stored on the client 22 or is accessible through the system 10. The application 24 shares student-specific information within the system 10 via a series of portals. As shown in FIGS. 2 and 3, the application 24 comprises a school portal 26, a parent portal 28, a system portal 30 and activity portal 32. Notably other portals are contemplated, without departing from the scope of the present invention.

As previously stated, by using the system 10 and application 24, student-specific information can be maintained remotely by parents, via, the internet or a telecommunication network, or similar mode of remote communication. The application 24 is remotely accessible from standard web-based computers and/or from the client 22, such as a smart phone, PDA or other electronic device capable of remote communication. Student specific data can be stored on a remote system or server, as previously disclosed, as well as in the client's memory. It is contemplated that the system 10 can be developed using a LAMP (Linux, Apache, MYSQL, PHP) stack or architecture. However, the system could be developed using other platforms such as .NET and SQL. Further, native Mobile Applications can be built for smartphones like the Apple iPhone platform using iPhone SDK and X-Code. Mobile applications will also be developed for Blackberry platform and Google Droid platform in later versions.

The parent portal module 28 enables parents, and/or users to maintain current up to date contact and health information for their student, and/or child. Users or parents, enter the contact, health information and/or records for the student and child into the system 10.

The client 22 is in communication with the remote system 10 and server 18. As such, when information or data is changed, modified and/or updated, the system 10 sends an alert to a selected school's system and gives the user the opportunity to validate the information. All validated information will be made available to the school to update the school's respective Student Information System using standard formats generally know to those skilled in the art.

Further, the parent portal 28 enables the user to access and register the student/child for various activities and organizations, such as field trips, chess club, sports, etc. It is further contemplated that a payment application and/or function can be provided to enable the parents to pay any registration fees associated with that activity remotely via the client 22.

As shown in FIG. 2 and FIG. 3, the school portal module 26 enables selected schools, and/or organization to collect their students' contact information and/or health information. This information is typically acquired in a State School Entrance Health Information form when a new student registers with the school, at the beginning of a school year and as and when the information changes.

The school portal module 28 comprises: 1. Student Health Information; 2. Immunization Certification from the Physician; and 3. Physical Examination Report from the Physician. The system 10, application 24 and school module cooperatively enable parents to maintain the aforementioned student-specific information. For example, when student-specific information is modified for a student, the school is notified through workflow and general procedures, and provided the opportunity to validate further the information. Preferably, validated information is available to the school to update their respective Student Information System or other Systems using standard formats. Emergency contact and certain parts of the Health information can be made available to First Responders and Activity Managers as needed via their smart phones, or a preferred remote client.

It is contemplated that the system 10 will be fully compliant with all relevant HIPPA and FERPA rules and regulations to share and disseminate student-specific information. Information locally stored in the system 10 and/or application 24 will be highly protected through various forms of access control. In addition, all critical data will be stored and transmitted using highly secure, encrypted methods generally known to those skilled in the art.

The activity portal 32 enables users, such as school administrators to setup, monitor and manage activities, such as fund raising programs, or similar school related activities. The activity portal module 32 allows Schools, Parent Teachers Associations and other Organizations that manage activities for Students in their Schools, to setup and manage the activities. Students that are eligible to participate in a selected activity are capable of being identified and notified at their respective smart phones or clients. In addition, parents can also be notified, such that the Parents can register their Student(s) for the activity and pay any fees (dues) associated with the selected activity from their computer or smart phone remotely. An Activity Manager will be notified of the registered participants through workflow. Funds collected by the application 10 are transferred to appropriate Activity Managers' Accounts.

Even though the design of the Activities Management module will be flexible enough to accommodate many types of activities, it is contemplated that the first release of the product will be developed to meet the requirements of the following activities:
1. Athletics—Football Team, Basketball Team payments
2. Extra Curricular Activities conducted at the School by the PTA
3. Field Trips
4. Book Purchases (not text books, these are additional story books etc., that Schools distribute, especially to Elementary Students as a fund-raiser)
5. Class Photo Purchases
6. School Souvenir, Year Book Purchases

The system portal 30 module enables authorized users of the system 10 to manage various system components. This will include management of School District, School Accounts, management of Activities Organizers, such as the PTA and management of third party vendors such as Books Providers, Photo Studios that would provide services for the activities.

The system portal 30 also comprises a Payment Processing application or engine. This payment processing application comprises the components necessary to receive payments from user, parents, activities registrants and transfer of funds to the appropriate schools, activity managers' accounts, generally known in the art. The payment processing application interfaces with desired PCI compliant systems to ensure credit card and other payment related data is completely secure and all transmissions will be fully encrypted.

In addition, the System Portal 30 manages the data exchange between the Schools and the system 10. This data exchange will follow the Schools Interoperability Framework (SIF) data exchange and process model.

Additionally, the system is designed to capture information related to medical service and interact with medical practitioners, physicians, emergency medical service providers, and similar medically related personnel. In an exemplary embodiment, the system enables the capture of information related to ongoing medical service at the school by a school nurse and to share that information with medical practitioners. The school nurse could request and receive recommendations or the practitioners could be alerted and could provide recommendations for their patients. Such actions could provide critical medical information in life saving situations. The system would enable primary care physicians, emergency responders, and other medical personnel to participate in the service being rendered to a student at a school by the school nurse for example.

The system would include a transaction screen to capture the nurse or other school personnel interacting with the student whenever the student seeks or needs medical attention at school. The system would employ a data exchange with the primary care physician or other medical personnel for that student to keep the physician updated of on medical service being provided.

The data exchange would also enable interaction between physicians and school personnel (i.e. the school nurse) to discuss and provide instruction on a recommended course of action based on his/her medical history. The medical information exchange would facilitate an accurate history of care provided to the student and such information would be available to the parents and service providers.

The foregoing examples have been provided merely for the purpose of explanation and are in no way to be construed as limiting of the present method and product disclosed herein. While the invention has been described with reference to various embodiments, it is understood that the words which have been used herein are words of description and illustration, rather than words of limitation. Further, although the invention has been described herein with reference to particular means, materials, and embodiments, the invention is not intended to be limited to the particulars disclosed herein; rather, the invention expands to all functionally equivalent structures, methods and uses, such as are within the scope of the appended claims. Those skilled in the art, having the benefit of the teachings of this specification, may affect numerous modifications thereto and changes may be made without departing from the scope and spirit of the invention in its aspects.

1. A system for sharing student-specific information comprising a server, a client in communication with the server, the system further comprising a school portal, user portal, activity portal and a system portal for remotely sharing student-specific data with the server, to facilitate communication between a user and selected school.
